(19) United States
(12) Patent Application Publication
(10) Pub. No.: US 2003/0012415 A1
(43) Pub. Date: Jan. 16, 2003

(54) Method and apparatus to biometrically authenticate MFP users

(76) Inventor: Travis M. Cossel, Boise, ID (US)

Correspondence Address: HEWLETT-PACKARD COMPANY, Intellectual Property Administration, P. O. BOX 272400, Fort Collins, CO, 80527-2400, US

(21) Appl. No.: 09/902,862

(22) Filed: Jul. 10, 2001

(51) Int. Cl. G06K 9/00; G06T 1/00; H04Q 1/00; H04B 1/00; H04B 3/00; G06F 7/00; G06T 7/00; G06F 7/04; H04Q 9/00; G05B 19/00; G08C 19/00; G05B 23/00; G08B 29/00

(52) U.S. Cl. 382/124; 340/5.83

(57) ABSTRACT

A system and method to biometrically authenticate multifunction peripheral (MFP) users is disclosed. To prevent abuse by unauthorized use, a biometric image is obtained by scanning a user's fingerprint. In some implementations, the user may be prompted for a user name. The system retrieves at least one biometric key for comparison to the biometric image, in some cases using the user name to facilitate location of the biometric key. Where the comparison indicates a match, the user is allowed access to the MFP and resources on the network in a manner consistent with a policy, such as allowing the user the same permissions as would be the case if the user logged on to the network via the user's workstation. Accordingly, the user has the benefit of access to the MFP, while the network security is maintained.

### TECHNICAL FIELD

The authentication of the users of computer peripherals is performed biometrically. In particular, the scanning capability of a multifunction peripheral is utilized to authenticate users by fingerprint comparison.

### BACKGROUND

Multifunction peripherals (MFPs) include support for a number of computer and peripheral functions within one device. The basic functionality included in many MFPs includes faxing, scanning, printing and copying. Due to the expense of many MFPs, and to their generally robust duty cycle, it is commonly the case that a number of users will access the same MFP over a network. Accordingly, for most users, the MFP will be at a somewhat remote location, as opposed to directly connected to their workstation.

Additional functionality added to some MFPs includes sending and receiving email, file transfers and “digital send.” Digital send can include such operations as scanning a document for transmission using file transfer protocols or by attachment to an email message. Accordingly, documents processed by an MFP may be scanned, copied, faxed or sent by a file transfer program to a user's computer or a public directory on a second computer. Performance of these and other operations give the user access to the network. As a result, network administrators must balance the benefit of convenient use by workers with the risk of breaching network security.

Traditionally, access to a secured network is achieved by entering a user name and password at a workstation. However, this method can be inconvenient when applied to an MFP, due to limited keyboarding resources and the generally public location in which such devices are maintained. As a result, many MFPs have become a location by which unauthorized access to a network may be obtained. Using an advanced MFP, privileges including email, file transfer, and fax functionality may be accessed. Without proper authorization, files may be copied, altered or erased; unauthorized faxing may result in long distance charges; unauthorized printing costs may not be assigned; email may be abused such as by mass transmission of spam; and other network disorder may result.

This issue will continue to grow in significance, as MFPs become more and more functional. With their increased functionality will come greater benefit and unprecedented network access for the users of MFPs; however, additional risks to network resources due to unauthorized use by unauthenticated users will pose an even greater challenge for network administrators.

### SUMMARY

Systems and methods for biometrically authenticating multifunction peripheral (MFP) users are disclosed. In one implementation of the system and method, an MFP includes a scanner defining a finger slot adjacent to an image window in a scanner portion of an MFP. By placing a finger within the finger slot, a biometric image of a user's finger may be made by the scanner. The authenticity of the biometric image is evaluated against a biometric key. Where the biometric image and key match, the user is authenticated.

### BRIEF DESCRIPTION OF THE DRAWINGS

The same numbers are used throughout the drawings to reference like features and components.

FIG. 1 is an illustration of an exemplary network within which an MFP is available.

FIG. 2 is a plan view of a version of the apparatus for biometrically authenticating multifunction peripheral (MFP) users, showing the upper surface of an MFP including a raised finger slot that allows access through which a copy of a user's fingerprint may be obtained.

FIG. 3 is an orthographic view of the MFP of FIG. 2, showing the lid of the flatbed scanner portion of the MFP in a raised orientation, as if to accept a document for scanning.

FIG. 4 is a cross-sectional view of the MFP of FIG. 2, additionally showing a user's finger inserted within the finger slot, and showing the scanning mechanism obtaining data for comparison to a biometric key obtained under verified circumstances from an authorized user.

FIG. 5 is a block diagram illustrating the relationship between exemplary software and data file structures associated with the method and apparatus to biometrically authenticate MFP users.

FIG. 6 is a flow diagram illustrating a method and the operative format of an apparatus to biometrically authenticate MFP users.

### DETAILED DESCRIPTION

A system and method to biometrically authenticate multifunction peripheral (MFP) users is disclosed. MFPs provide the functionality previously contained within a plurality of computer peripherals. Consequently, the user of an MFP is provided with unprecedented access to the network to which it is connected. To prevent abuse of such privileges, the user is required to insert a thumb or index finger into a finger slot defined in the hinged cover of the scanner portion of the MFP. The user's fingerprint is then scanned and digitized to form a biometric image. In some implementations, the user may be prompted for a user name. The system then retrieves at least one biometric key for comparison to the biometric image, locating the biometric key with the user name, when available. Where the comparison indicates a match, the user is allowed access to the MFP and the network in a manner consistent with policy, such as allowing the user the same permissions as would be the case if the user logged on to the network via the user's workstation. Accordingly, the user has the benefit of access to the MFP, while the network security is maintained.

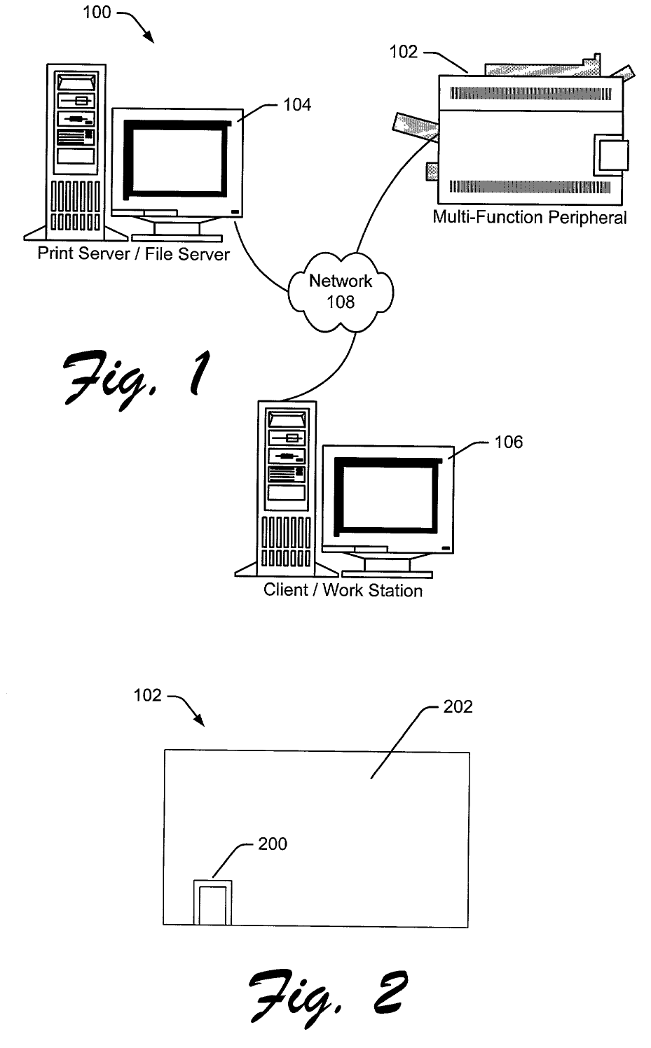

FIG. 1 shows a network environment 100, having a multifunction peripheral (MFP) 102, a server 104 or similar administrative computing device and a workstation 106. A network 108 connects the above devices, and may be in the form of a LAN, an intranet, the Internet or other network technology. The MFP's functional capabilities typically include: printing, copying, scanning, faxing, email and digital send capabilities. Email includes the ability to send as an attachment a file associated with the scanned image of a paper document. Digital send capabilities include the ability to send files to and from file systems over which the user has the appropriate permissions, using email, file transfer protocol or other file transfer technology.

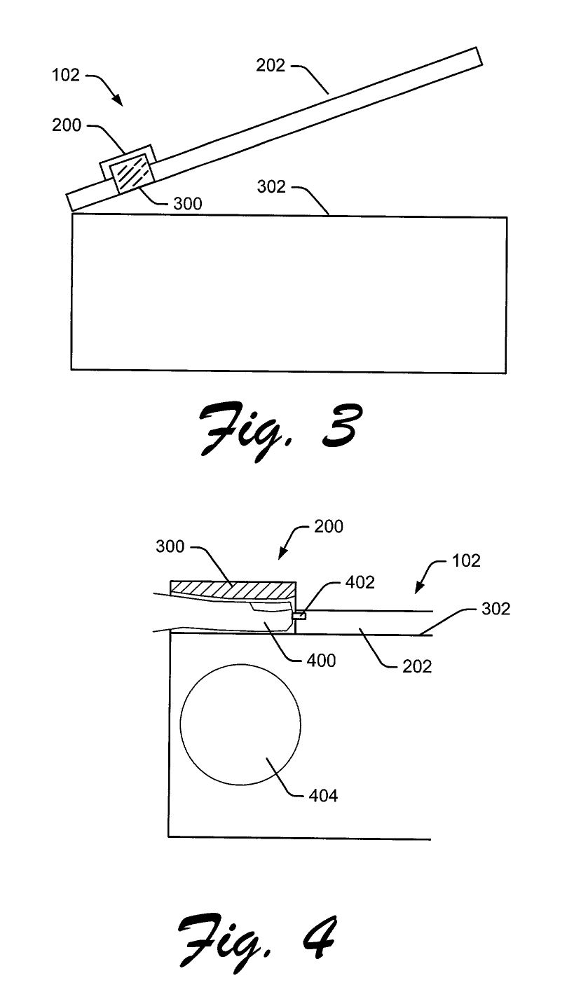

FIG. 2 shows a top plan view of the MFP 102. A finger slot 200 is defined in the hinged lid 202 of the scanner portion of the MFP. The finger slot allows a user to insert a thumb or index finger into the MFP at a position wherein the fingertip is against the glass image window of the scanner, where it can easily be scanned.

FIG. 3 shows a side orthographic view of the MFP 102 with the lid of the flatbed scanner raised to allow placement of a sheet of paper to be scanned on the image window 302. The finger slot 200 is filled with a shroud 300, made from foam rubber or similar substance. The shroud prevents light from entering the finger slot when the MFP is being used to scan or photocopy documents in a conventional manner. Additionally, the shroud tends to block light from entering the finger slot when a user's finger is inserted into the slot.

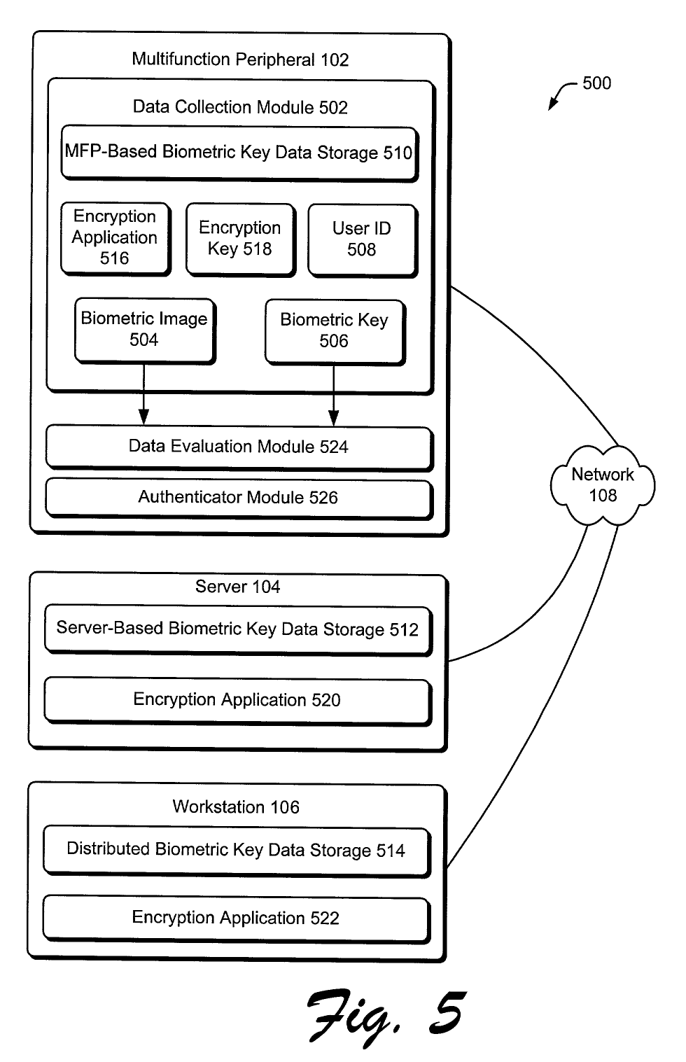

FIG. 4 shows a cross-sectional view of the finger slot 200 in use. The user's index finger 400 is within the finger slot. As a result, the shroud 300 is somewhat compressed. A sensor switch 402 detects the user's finger, typically using an optical or pressure sensor. In response to activation of the switch, the scanning mechanism 404 obtains fingerprint data associated with a biometric image.

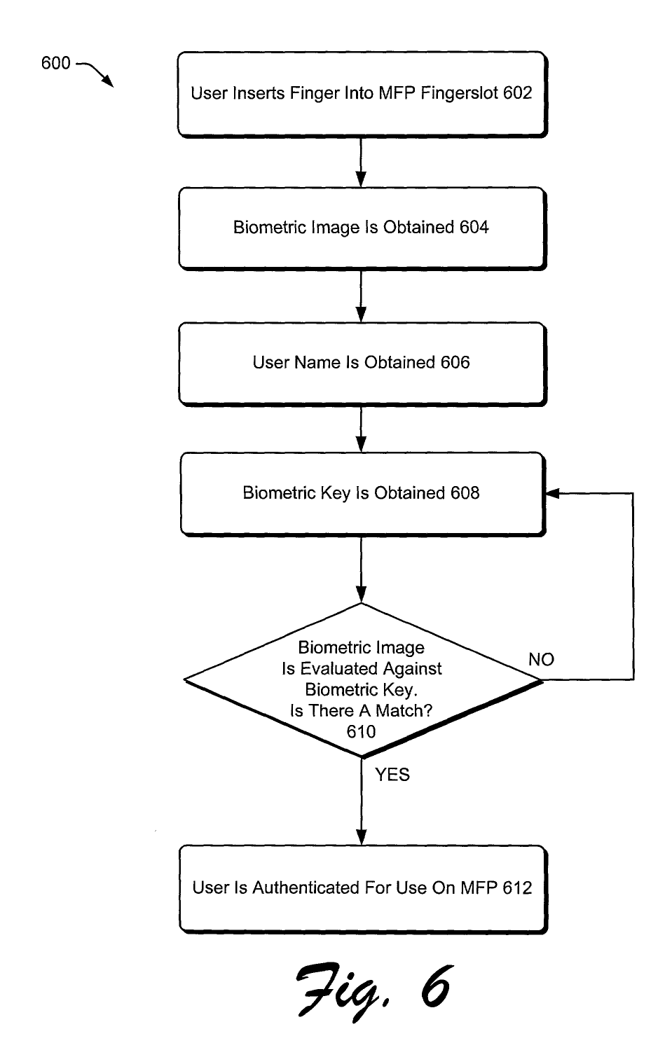

FIG. 5 shows a block diagram illustrating a software structure 500 for biometrically authenticating authorized MFP users. A biometric image is obtained by communication with devices used to scan a user's finger while inserted into the finger slot defined within the cover protecting the image window of the scanner portion of the MFP. The biometric image is compared to one or more biometric keys derived from data previously obtained in a verified manner from authorized users of the MFP. Where the biometric image matches the biometric key, the user is authenticated, and is accordingly logged onto the MFP.

A data collection module 502 obtains a file associated with a biometric image 504 from the user, at least one biometric key 506 to which to compare the biometric image, and in an optional embodiment, a user name or ID 508. The biometric image is generated, as seen in FIG. 4, in response to insertion of the user's finger 400 within the finger slot 200, activation of the switch 402 and scanning of the finger by the mechanism 404 contained within the MFP. As this process is completed, a biometric image in the form of a digital file is created. The data collection module retrieves this biometric image 504 when it becomes available.

Optionally, the data collection module 502 may request that the user enter a user name 508. The request may be made on an LCD screen or other available output device. The user name may be entered using the keypad or other available input device. The user name facilitates the rapid location of the appropriate biometric key.

The data collection module obtains one or more biometric keys 506, against which the biometric image may be tested to determine a match. The biometric keys are biometric images that have been obtained in circumstances that provide confidence that the originators of the biometric keys, i.e. the individuals whose fingerprints were obtained, are actually authorized to use the MFP. Where a user name or ID 508 is available, the data collection module obtains the biometric key associated with the user name. Where a user name is not available, the data collection module obtains a sequence of biometric keys for comparison to the biometric image.

The biometric keys may be stored within an MFP-based biometric key data storage area 510. The data storage module may be implemented in the form of a database or management information base (MIB). If the MFP has a disk drive or other form of mass media storage, the MFP-based biometric key data storage allows convenient access to the biometric keys without transferring the biometric keys over the network.

The biometric keys may alternatively be stored in a server-based biometric key data storage 512 contained on the server 104 or in a distributed biometric key data storage 514, wherein each biometric key is stored on a workstation 106 associated with, or used by, the originator of the biometric key. Where the biometric keys are contained within a server-based or distributed storage, retrieval by the data collection module will result in the biometric keys passing over the network 108. Accordingly, an encryption application 516 and encryption key 518 resident on the multifunction peripheral may be used to communicate with encryption applications 520, 522 resident on the server 104 or workstation 106. Use of the encryption applications protects the biometric keys with strong encryption as they pass over the network.

A data evaluation module 524 compares the biometric image to one or more biometric keys. Where the comparison results in a match, the user is authenticated to use the MFP. Where a match is not found, a failure message is sent to an output device within the MFP, such as an LCD screen.

Upon successfully matching the biometric image with a biometric key, an authentication module 526 logs the user onto the MFP. The user is then able to use all of the functionality of the MFP that is consistent with the user's permissions to read or write to a given file system.

FIG. 6 shows a method 600 by which an authorized user can become authenticated to use an MFP. At block 602, a user inserts a finger or thumb into the finger slot 200 of an MFP adjacent to the image window 302. As a result, the light-blocking shroud 300 is somewhat compressed. The user's finger activates sensor switch 402, which in turn initiates the creation of the biometric image.

At block 604, the data collection module 502 obtains a digitized file associated with the biometric image.

At block 606, in an optional implementation, the data collection module prompts the user for a user name or identifying number. The user name can be used to facilitate the desired retrieval of the biometric key and to reduce the time spent evaluating biometric keys that are not a match to the biometric image. The user may be prompted to enter a user name by a written command on an LCD display contained by the MFP, or by a similar output device. The user may enter a user name, code or other identifying data by use of a keypad or similar input device that is part of the MFP. Because security is based on biometric data, the user name can be easy-to-remember public knowledge, such as the user's telephone number.

At block 608, a biometric key is obtained. Typically, the biometric key is a file containing digital information associated with a user's thumb or fingerprint. Where a user name, ID or other information about the user was supplied at block 606, the user name may be used with an index or similar directory to obtain the correct biometric key. Where a user name is not available, biometric keys may be obtained in any desired sequence.

Where the biometric keys are contained in storage 510 within the MFP, the biometric keys are easily obtained without the use of the network 108. Where the biometric keys are stored on the server-based biometric key data storage 512 or the distributed biometric key data storage 514, the biometric keys are obtained over the network. Optionally, the encryption application 516 supplies an encryption key 518 to the server-based biometric key data storage 512 or to the distributed biometric key data storage 514. The encryption applications 520, 522, located on the server or distributed locations, respectively, encrypt the biometric key file and transmits it back to the data collection module 502.

At block 610, the data evaluation module 524 compares the biometric image to the biometric key. Where there is a match, the user is authenticated at block 612. Where there is no match, another biometric key is obtained at block 608.

At block 612, the user is authenticated for access to the MFP, and accorded the appropriate permissions.

Conclusion

The techniques described above provide an inexpensive apparatus and method of use that authenticates users to access the functionality of an MFP. As a result, users benefit from the convenient authentication process. By comparing biometric images obtained by the MFP itself to previously recorded and verified biometric keys, the identity of the user is verified. Accordingly, devices on the network are protected by exclusion of those not authorized to use resources connected to the network.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method, comprising:
scanning a user's finger contained within a finger slot of a multifunction peripheral to obtain a biometric image;
obtaining a biometric image by scanning a user's finger contained within the finger slot;
comparing the biometric image to a biometric key; and
authenticating a user of the multifunction peripheral based on a match between the biometric image and the biometric key.

2. The method of claim 1, additionally comprising distributing storage of each biometric key to a file system of which an originator of the biometric key has control.

3. The method of claim 1, additionally comprising prompting the user for entry of a user name to direct retrieval of the biometric key.

4. The method of claim 1, additionally comprising distributing the storage of biometric keys associated with authorized users of the multifunction peripheral to workstations assigned to the authorized users of the multifunction peripheral, respectively.

5. The method of claim 1, additionally comprising basing the storage of biometric keys on a server in communication with the multifunction peripheral.

6. The method of claim 1, additionally comprising basing the storage of biometric keys on the multifunction peripheral.

7. The method of claim 1, additionally comprising activating the scanner portion of the multifunction peripheral in response to a sensor detecting the user's finger within the finger slot.

8. The method of claim 1, additionally comprising blocking light from entering the finger slot with a resilient shroud.

9. A system, comprising:
a multifunction peripheral;
a finger slot adjacent to an image window in a scanner portion of the multifunction peripheral;
a data collection module configured to obtain a biometric image by scanning a user's finger contained within the finger slot;
a data evaluation module configured to compare the biometric image to a biometric key; and
an authenticator module configured to provide access to the multifunction peripheral based a match between the biometric image and the biometric key.

10. The system of claim 9, additionally comprising distributed biometric key storage configured to distribute storage of each biometric key within a file system of which an originator of the biometric key has control.

11. The system of claim 9, additionally comprising a data collection module to prompt the user to enter a user name to direct retrieval of the biometric key from a distributed location.

12. The system of claim 9, additionally comprising distributed biometric key storage configured to distribute storage of biometric keys associated with authorized users of the multifunction peripheral on workstations assigned to authorized users of the multifunction peripheral, respectively.

13. The system of claim 9, additionally comprising server based storage of biometric keys, wherein a server upon which the biometric keys are stored is in communication with the multifunction peripheral.

14. The system of claim 9, additionally comprising multifunction peripheral based storage of biometric keys.

15. The system of claim 9, additionally comprising a sensor switch adjacent to the finger slot to activate the scanner portion of the multifunction peripheral in response to detection of the user's finger.

16. The system of claim 9, additionally comprising a shroud within the finger slot.

17. A processor-readable medium having processor-readable instructions thereon which, when executed by one or more processors cause the one or more processors to:
obtain a biometric image by scanning a finger of a user contained within a finger slot defined within the cover of a scanner portion of a multifunction peripheral;
compare the biometric image to a biometric key; and
authenticate the user of the multifunction peripheral based on a match between the biometric image and the biometric key.

18. The processor-readable media of claim 17 having processor-readable instructions thereon which, when executed by one or more processors cause the one or more processors to prompt the user for entry of a user name to direct retrieval of the biometric key.

19. The processor-readable media of claim 17 having processor-readable instructions thereon which, when executed by one or more processors cause the one or more processors to distribute storage of each biometric key to a file system over which an originator of the biometric key has control.

20. The processor-readable media of claim 17 having processor-readable instructions thereon which, when executed by one or more processors cause the one or more processors to base storage of each biometric key on storage media contained within the multifunction peripheral.
